(19) United States
(12) Patent Application Publication
(10) Pub. No.: US 2024/0029973 A1
(43) Pub. Date: Jan. 25, 2024

(54) ELECTRICALLY CONDUCTIVE MEMBRANE PRESSURE SWITCH

(71) Applicant: Clean Energy Labs, LLC, Austin, TX (US)

(72) Inventor: Joseph F. Pinkerton, Austin, TX (US)

(73) Assignee: CLEAN ENERGY LABS, LLC, Austin, TX (US)

(21) Appl. No.: 18/254,839

(22) PCT Filed: Dec. 6, 2021
(86) PCT No.: PCT/US2021/062011

§ 371 Date: Jun. 9, 2023

Related U.S. Application Data
(60) Provisional application No. 63/121,446, filed on Dec. 4, 2020.

(51) Int. Cl. H01H 35/34

(52) U.S. Cl. CPC H01H 35/346; H01H 2201/02; H01H 2201/026

(57) ABSTRACT

An electrically conductive membrane pressure switch, such as a graphene membrane pressure switch. The electrically conductive membrane pressure switch includes an electrically conductive membrane, source, drain plane, actuator, and movable element (such as a piston element). The actuator drives the movable element to create a pressure differential that moves the suspended section of the electrically conductive membrane between its on, off, and neutral states.

### RELATED PATENTS/PATENT APPLICATIONS

This application claims priority to U.S. Patent Application No. 63/121,446, filed Dec. 4, 2020, and entitled “Electrically Conductive Membrane Pressure Switch.” This patent application is incorporated herein in its entirety.

### TECHNICAL FIELD

The present invention relates to an electrically conductive membrane pressure switch, such as a graphene membrane pressure switch.

### BACKGROUND

A switch that includes an electrically conductive membrane is an electrically conductive membrane switch. When the electrically conductive membrane is a graphene membrane, the switch is a graphene membrane switch. Graphene membranes (also otherwise referred to as “graphene drums”) have been manufactured using a process such as disclosed in Lee et al. Science, 2008, 321, 385-388. U.S. Pat. No. 8,483,087, entitled “Nanoelectromechanical Tunneling Current Switch Systems,” issued Jul. 9, 2013, to Pinkerton (the “Pinkerton '087 patent”) described tunneling current switch assemblies having graphene drums (with graphene drums generally having a diameter between about 500 nm and about 1500 nm). U.S. Pat. No. 8,755,212, entitled “Non-Volatile Graphene-Drum Memory Chip, issued Jun. 17, 2014, to Pinkerton et al. (the “Pinkerton '212 patent”) and U.S. Pat. No. 8,778,197, entitled “Graphene Windows, Methods of Making Same, and Devices Containing Same” issued Jul. 14, 2014, to Everett et al. (the “Everett '197 patent”) further describe switch assemblies having graphene drums. U.S. Patent Appl. Publ. No. 20140124340, entitled “Electrically-Conductive Membrane Switch, published May 8, 2014, Pinkerton et al. (the “Pinkerton '340 application”) describes electrically conductive membrane switches, including graphene membrane switches. These patents and patent applications are incorporated herein in their entirety.

Herein, such electrically conductive membrane switches described in the Pinkerton '212 patent, the Everett '197 patent, and the Pinkerton '340 application will be referred to as, and are representative examples of “electrically conductive membrane electrostatic switches.” I.e., electrically conductive membrane electrostatic switches include, but are not limited to, the electrically conductive membrane switches described in the Pinkerton '212 patent, the Everett '197 patent, and the Pinkerton '340 application When the electrically conductive membrane is graphene, the electrically conductive membrane electrostatic switches can also be referred to as “graphene membrane electrostatic switches.”

FIGS. 1 and 2A-2B depict the cross-sectional illustration of an electrically conductive membrane electrostatic switch described in the Pinkerton '340 application. As shown in FIG. 1, the electrically conductive membrane electrostatic switch 100 (which is a graphene membrane electrostatic switch) has source 101, drain 107, and gate 103 metal layers that do not overlap. (Electrically conductive membrane 201 (which is a graphene membrane) is not shown in FIG. 1).

There is not a short oxide path between the metal layers (that can lead to a low hold-off voltage) and also the capacitance between the metal layers is relatively low. There are vent lines 104 and 105 between source 101 and gate 103. The tall drain post enabled a thick layer of oxide 106 between gate 103 and drain 107 metals (which increased hold-off voltage between gate 103 and drain 107). The drain trace 107 is also on a tall pillar of oxide 108, which separates drain trace 107 from both the source 101 and gate 103 metal layers. The gate 103 and drain 107 metal layers outside of the cavity are not connected to any voltages so there is not a voltage breakdown path between the oxide 106, 108, and 111 separating these layers and the source/top 101 metal layer.

FIG. 1 further shows that the drain trace 107 has a metal 107b on top of metal 107a so that drain trace 107 is closer to the center part of the electrically conductive membrane 201 (which membrane again is not shown in FIG. 1) than the gate 103 metal. (Electrically conductive membrane 201 (which is a graphene membrane) is shown in FIG. 2). Metal 107a in FIG. 1 (as well as metals 101a and 109a) can be a good electrical conductor like Al, and metal 107b (as well as metals 101b and 109b) should be a good electrical conductor that does not form an oxide layer (which would increase electrically conductive membrane electrostatic switch “on” state losses) like Au or Pt. Metal 109a is an inactive metal layer (no voltage is applied to and no current is routed through this layer) and gate 103 is an active metal layer (voltage is applied to or current is routed through this layer).

FIGS. 2A-2B shows the electrically conductive membrane electrostatic switch 100 with electrically conductive membrane 201 in its “off” and “on” states, respectively. The center portion of graphene 201 deflects toward the center portion of the drain trace 107. Electrically conductive membrane 201 contacts the center of the drain trace 107 but not the gate post (since the center portion of the electrically conductive membrane 201 deflects with a lower force than the portions near the edge of the device).

The current can enter the top of the switch and exit at the bottom of the switch. The current enters at electrically conductive membrane 201, flows into drain trace 107 then flows down through the drain post (not shown in FIGS. 1 and 2A-2B), then into drain plane 102 metal on top of the substrate 113, and then through a large metal drain (not shown) via to a drain electrode (not shown) on the bottom of substrate 113 (Si or other support wafer). In the “off” state, the drain trace 107 and electrically conductive membrane 201 (and gate 103 and electrically conductive membrane 201) are separated by vacuum (which can hold off around 5 V per micron or around ten times more voltage/nm than a typical dielectric greater than 100 nm thick). The gate and drain traces are separated by vacuum or by tall oxide structures. In some embodiments, the optimal oxide path between the gate/drain/source metals is at least around ten times the distance of the vacuum path between these structures to maximize hold-off voltage.

A metal can be used coated on the graphene membrane to lower the “on” resistance of the switch. Alternatively, the graphene membrane can have more than one layer that can be used to hold off a higher voltage between source and drain. Such additional layers also increase current carrying capacity.

### SUMMARY OF THE INVENTION

The present invention is directed an electrically conductive membrane switch that uses gas pressure to actuate the electrically conductive membrane (such as a graphene membrane) in place of actuating the switch utilizing electrostatic forces.

In general, in one aspect, the invention features an electrically conductive membrane pressure switch that includes an electrically conductive membrane comprising a suspended section of the electrically conductive membrane, a source, a drain plane, an actuator, and a movable element. The actuator is operable to drive the movable element to create a pressure differential that moves the suspended section of the electrically conductive membrane between on, off, and neutral states. The electrically conductive membrane is substantially in a plane when the suspended section of the electrically conductive membrane is in the neutral state. The driving of the movable element away from the electrically conductive membrane results in a pressure drop that moves the suspended section of the electrically conductive membrane away from the source and drain plain to the off state. The driving of the movable element toward the electrically conductive membrane results in a pressure increase that moves the suspended section of the electrically conductive membrane toward the drain plain to the on state.

Implementations of the invention can include one or more of the following features:

The electrically conductive membrane can be a graphene membrane.

The electrically conductive membrane can be a polymer film membrane that is coated with a conductive coating.

The conductive coating can be a thin coating of metal.

The metal can be gold or aluminum.

The polymer film membrane can be selected from the group consisting of polyester, polyethylene (“PE”), polypropylene (“PP”), polyvinyl chloride (“PVC”), and polydimethylsiloxane (“PDMS”), and combinations thereof.

The polymer film membrane can include a thermoplastic polymer resin of the polyester.

The movable element can be part of the actuator.

The actuator can be a linear actuator.

The actuator can be a piezoelectric actuator.

The electrically conductive membrane pressure switch can have a piezoelectric transducer that includes the piezoelectric actuator.

The piezoelectric actuator transducer can further include the movable element.

The movable element can be substantially along the same plain of the electrically conductive membrane when the suspended section of the electrically conductive membrane is in the neutral state.

The electrically conductive membrane pressure switch of claim 1 can further include a chamber bounded at least in part by the movable element and the electrically conductive membrane.

The chamber can be further bounded by a flexible support.

The flexible support can include a rubber o-ring.

The chamber can be airtight.

The chamber can include air.

The chamber can include sulfur hexafluoride.

The chamber can include a non-reactive gas.

The non-reactive gas can be nitrogen or a noble gas.

The movable element can include a piston element.

In general, in another aspect, the invention features a method of using an electrically conductive membrane pressure switch. The electrically conductive membrane pressure switch includes (i) an electrically conductive membrane comprising a suspended section of the electrically conductive membrane, (ii) a source, (iii) a drain plane, (iv) an actuator, and (v) a movable element. The method includes utilizing the actuator to drive the movable element to create a pressure differential that moves the suspended section of the electrically conductive membrane between on, off, and neutral states. The electrically conductive membrane is substantially in a plane when the suspended section of the electrically conductive membrane is in the neutral state. Utilizing the actuator to drive of the movable element away from the electrically conductive membrane results in a pressure drop that moves the suspended section of the electrically conductive membrane away from the source and drain plain to the off state. Utilizing the actuator to drive the movable element toward the electrically conductive membrane results in a pressure increase that moves the suspended section of the electrically conductive membrane toward the drain plain to the on state.

Implementations of the invention can include one or more of the following features:

The electrically conductive membrane pressure switch can be an electrically conductive membrane pressure switch of any of the above-described electrically conductive membrane pressure switches.

### DESCRIPTION OF DRAWINGS

FIG. 1 depicts a cross-sectional illustration of an electrically conductive membrane electrostatic switch.

FIGS. 2A-2B depict the cross-sectional illustration of the electrically conductive membrane electrostatic switch shown in FIG. 1 with the electrically conductive membrane in its “off” and “on” states, respectively.

FIG. 3 depicts a cross-sectional illustration of an electrically conductive membrane pressure switch of the present invention (in its “neutral” state).

FIGS. 4A-4B depict the cross-sectional illustration of the electrically conductive membrane pressure switch shown in FIG. 3 with the electrically conductive membrane in its “off” and “on” states, respectively.

### DETAILED DESCRIPTION

The present invention relates an improved electrically conductive membrane switch that uses gas pressure to actuate the electrically conductive membrane (such as a graphene membrane) in place of actuating the switch utilizing electrostatic forces. The improved electrically conductive membrane switch is referred to as an “electrically conductive pressure switch.” When the electrically conductive membrane is graphene, the electrically conductive membrane pressure switch can also be referred to as a “graphene membrane pressure switch.”

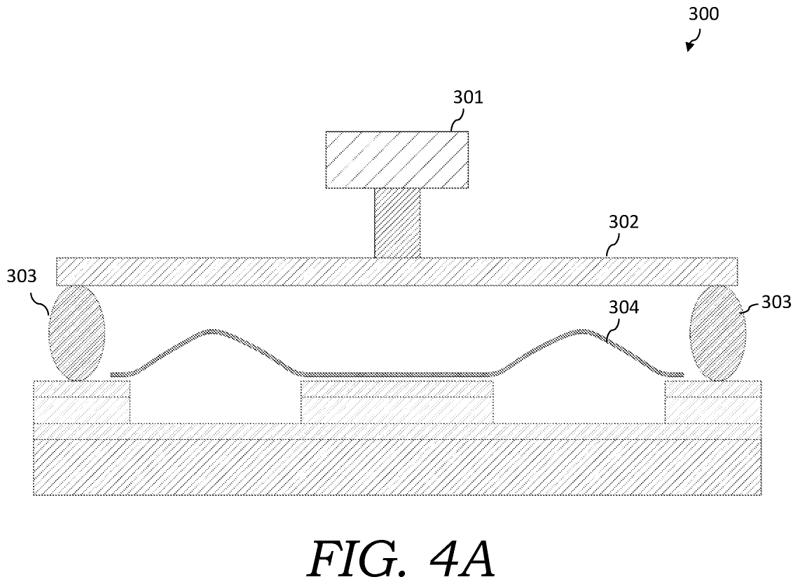

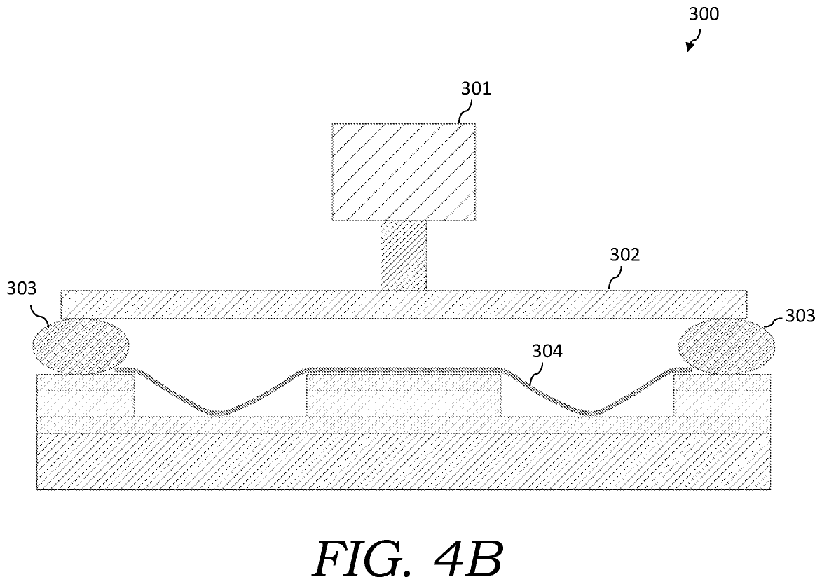

FIGS. 3 and 4A-4B depict the cross-sectional illustration of electrically conductive membrane pressure switch 300. Electrically conductive membrane pressure switch 300 is similar to electrically conductive membrane electrostatic switch 100 in that electrically conductive membrane pressure switch 300 has an electrically conductive membrane 304 (such as a graphene membrane), source 305 on oxide 306, and drain plane 307 on top of substrate 308 that are similar to electrically conductive membrane 201, source 101 on oxide 111, and drain plane 102 on top of substrate 113, respectively, of electrically conductive membrane electrostatic switch 100. However, electrically conductive membrane pressure switch 300 does not include gate 103 and drain 107 of electrically conductive membrane electrostatic switch 100, which results in electrically conductive membrane pressure switch 300 having three metal/oxide layers as compared to the six metal oxide layers in electrically conductive membrane electrostatic switch 100. Generally, the metal of source 305 and drain plane 307 is gold, oxide 306 is silicon dioxide, and substrate 308 is Si or some other support wafer.

The electrically conductive membrane 304 can be graphene, and alternatively, can be made of other materials, such as a polymer film membrane that is coated with a conductive coating, such as a very thin coating of metal (gold or alternatively aluminum deposited on top of the polymer film membrane). The polymer of the metal-coated polymer film membrane can be, for example, any of polyester (such as Mylar), polyethylene (“PE”), polypropylene (“PP”), polyvinyl chloride (“PVC”), and polydimethylsiloxane (“PDMS”). Mylar (manufactured by DuPont Teijin Films US, Chester, Virginia) is the common thermoplastic polymer resin of the polyester family that is used in fibers for clothing, containers for liquids and foods, thermoforming for manufacturing, and in combination with glass fiber for engineering resins.

Electrically conductive membrane pressure switch 300 further has a linear actuator 301 (such as a piezoelectric actuator) and a movable element, such as piston element 302, that runs substantially parallel to the plane of electrically conductive membrane 304 in its “neutral” state (which is shown in FIG. 3). This provides that both piston element 302 and electrically conductive membrane 304 can both move in the positive and negative z-direction. Piston element 302 is moved in the positive and negative z-direction by linear actuator 301. Piston element 302 can be stainless steel. In some embodiments, piston element 302 is ridged. A piezoelectric transducer can be used as both the actuator and the piston element.

Electrically conductive membrane pressure switch 300 further has a flexible support 303 (such as a rubber o-ring), which expands and contracts as piston element 302 moves in the positive and negative z-direction to maintain an airtight boundary in chamber 311. Generally, the gas in chamber 311 is air, but can be other types of gases, such as sulfur hexafluoride (which has arc suppression characteristics that can be advantageous), or a non-reactive gas, such as nitrogen or a noble gas.

By moving piston element 302 in the positive z-direction (which is away from electrically conductive membrane 304), there is a pressure drop within chamber 311, which results in the movement of the suspended section of electrically conductive membrane 304 in the positive z-direction, such as shown in FIG. 4A. FIG. 4A shows electrically conductive membrane pressure switch 300 in its “off” state.

By moving piston element 302 in the negative z-direction (which is toward electrically conductive membrane 304), there is a pressure increase within chamber 311, which results in the movement of the suspended section of electrically conductive membrane 304 in the negative z-direction, such as shown in FIG. 4B. FIG. 4B shows electrically conductive membrane pressure switch 300 in its “on” state.

The electrically conductive membrane pressure switch 300 will pass an electrical current between the source and drain only when it is in its “on” state; it will not pass an electrical current between the source and drain when in its “off” or “neutral” states.

This provides that electrically conductive membrane pressure switch 300 uses pressure (gas pressure) to actuate the switch in place of the electrostatic forces used to actuate electrically conductive membrane electrostatic switch 100.

A comparison between graphene membrane pressure switches with the graphene membrane electrostatic switches showed a number of advantages of the electrically conductive membrane switches. These advantages include about 45 times less on resistance (reducing on losses by 45 times), the ability to switch at about 5 times the open circuit voltage, two times fewer metal/oxide layers (lower cost), and at least 10 times the number of on/off cycles.

Each graphene membrane switch (such as a graphene membrane electrostatic switch and a graphene membrane pressure switch) has about 1000 ohms of contact resistance so placing as many in parallel as possible is desirable. As compared to graphene membrane electrostatic switch, the minimum diameter of graphene membrane pressure switch is about 3 times smaller (for a given photolithography feature size limit) and so it takes up 9 times less space on the substrate. This means there can be 9 times more switches in parallel and so 9 times less on resistance.

Because electrostatic actuation is limited by the breakdown voltage between graphene and gate trace in a graphene membrane electrostatic switch, the source-drain distance in a graphene membrane electrostatic switch is about 5 times less than the source-drain distance of a graphene membrane pressure switch, which allows the graphene membrane pressure switch to have an open circuit voltage about 5 times higher than the graphene membrane electrostatic switch. This means that, to reach same the switching voltage as one graphene membrane pressure switch, 5 graphene membrane electrostatics switches would need to be placed in series, which increases on resistance by 5 times. The net result is the graphene membrane pressure switch has 45 times (9×5) less on resistance (less on power losses) than the graphene membrane electrostatic switch.

This shows that graphene membrane pressure switches have the advantage of about 45 times less on resistance (reducing on losses by 45 times) and have the ability to switch at about times the open circuit voltage.

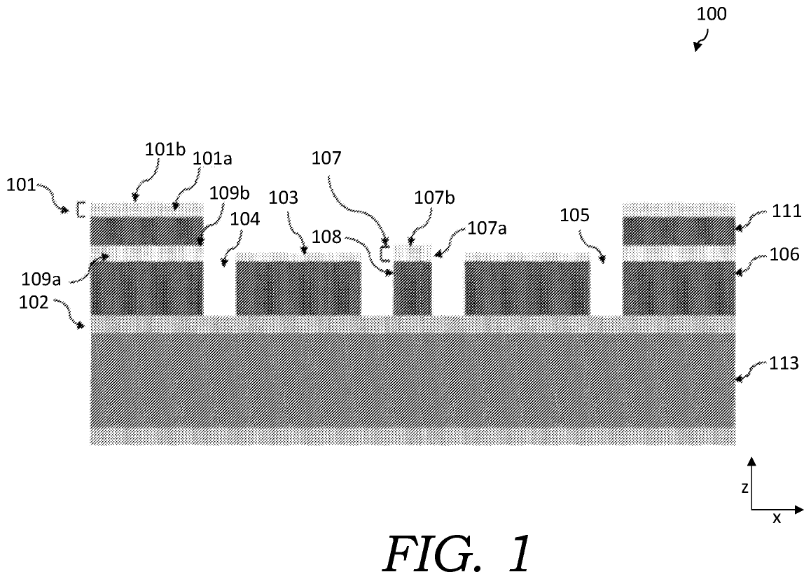

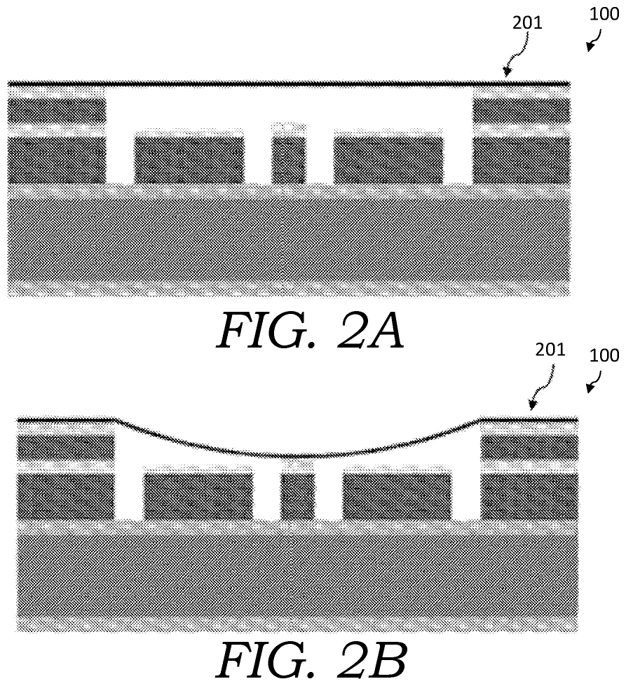

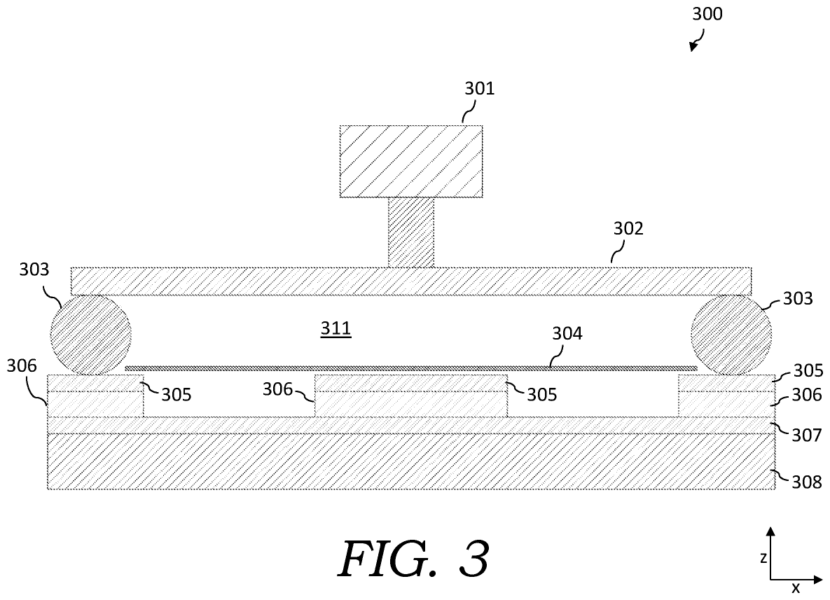

As for the advantage of two times fewer metal/oxide layers (lower cost), as shown by a comparison of FIGS. 1 and 3, graphene membrane pressure switch 300 has 3 metal/oxide layers and graphene membrane electrostatic switch 100 has 6 metal/oxide layers. Thus, the graphene membrane pressure switch will cost less to make.

As for the advantage of the graphene membrane pressure switch having at least 10 times the number of on/off cycles, this has significant benefits. The graphene membrane pressure switch's ability to achieve at least 10 times as many lifetime on/off cycles means that the graphene membrane pressure switch will last at least 10 times as long in a given application.

The gate and drain forces of the graphene membrane electrostatic switch are in the same direction (negative-z direction in FIG. 1) and so graphene will “run away” when the graphene gets near the drain and accelerates toward the drain, which causes damage and limits cycle life. When graphene membrane pressure switch starts to run away toward the drain, the internal pressure in chamber 311 decreases and the pressure between electrically conductive membrane 304 and drain trace 307 increases and this creates a strong force that is opposite of the graphene-drain attractive force in the graphene membrane electrostatic switch. This opposite force produced in the graphene membrane pressure switch prevents the graphene from entering a runaway mode so the graphene can “land” gently on the drain. This gentle landing in the graphene membrane pressure switch increases cycle life by at least a factor of 10.

Furthermore, the actuator (such as piezoelectric actuator) of the graphene membrane pressure switch drives the piston element to create an AC gas pressure change above the graphene membrane. Actuators can operate at frequencies in 20 kHz to few MHz range. Unlike semiconductor switches, there should be few, if any, switching losses, since there is no semiconductor transition time between fully off and fully on (no time the switch is partially on and thus on with relatively high electrical resistance).

In some embodiments, the electrically conductive membrane of the electrically conductive membrane pressure switch can have a small perforation that will permit air (or other gas) to equalize any long-term pressure differential between the gas pressure on one side of the electrically conductive membrane related to the other side. In such circumstance, rapid pressure changes can still actuate the electrically conductive membrane pressure switch because the size of the perforation limits the gas flow to negligible levels over one motion cycle of the electrically conductive membrane. For instance, the perforation can have a diameter between 10 nm and 50 nm.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. An electrically conductive membrane pressure switch comprising:
(a) an electrically conductive membrane comprising a suspended section of the electrically conductive membrane;
(b) a source;
(c) a drain plane;
(d) an actuator; and
(e) a movable element, wherein
(i) the actuator is operable to drive the movable element to create a pressure differential that moves the suspended section of the electrically conductive membrane between on, off, and neutral states,
(ii) the electrically conductive membrane is substantially in a plane when the suspended section of the electrically conductive membrane is in the neutral state,
(iii) the driving of the moveable element away from the electrically conductive membrane results in a pressure drop that moves the suspended section of the electrically conductive membrane away from the source and drain plain to the off state, and
(iv) the driving of the movable element toward the electrically conductive membrane results in a pressure increase that moves the suspended section of the electrically conductive membrane toward the drain plain to the on state.

2. The electrically conductive membrane pressure switch of claim 1, wherein the electrically conductive membrane is a graphene membrane.

3. The electrically conductive membrane pressure switch of claim 1, wherein the electrically conductive membrane is a polymer film membrane that is coated with a conductive coating.

4. The electrically conductive membrane pressure switch of claim 3, wherein the conductive coating is a thin coating of metal.

5. The electrically conductive membrane pressure switch of claim 4, wherein the metal is gold or aluminum.

6. The electrically conductive membrane pressure switch of claim 3, wherein the polymer film membrane is selected from the group consisting of polyester, polyethylene (“PE”), polypropylene (“PP”), polyvinyl chloride (“PVC”), and polydimethylsiloxane (“PDMS”), and combinations thereof.

7. The electrically conductive membrane pressure switch of claim 3, wherein the polymer film membrane comprises a thermoplastic polymer resin of the polyester.

8. The electrically conductive membrane pressure switch of claim 1, wherein the movable element is part of the actuator.

9. The electrically conductive membrane pressure switch of claim 1, wherein the actuator is a linear actuator.

10. The electrically conductive membrane pressure switch of claim 1, wherein the actuator is a piezoelectric actuator.

11. The electrically conductive membrane pressure switch of claim 10, wherein the electrically conductive membrane pressure switch has a piezoelectric transducer comprising the piezoelectric actuator.

12. The electrically conductive membrane pressure switch of claim 11, wherein the piezoelectric actuator transducer further comprises the movable element.

13. The electrically conductive membrane pressure switch of claim 11, wherein the movable element is substantially along the same plain of the electrically conductive membrane when the suspended section of the electrically conductive membrane is in the neutral state.

14. The electrically conductive membrane pressure switch of claim 1 further comprising a chamber bounded at least in part by the movable element and the electrically conductive membrane.

15. The electrically conductive membrane switch of claim 14, wherein the chamber is further bounded by a flexible support.

16. The electrically conductive membrane switch of claim 15, wherein the flexible support comprises a rubber o-ring.

17. The electrically conductive membrane switch of claim 14, wherein the chamber is airtight.

18. The electrically conductive membrane switch of claim 17, wherein the chamber comprises air.

19. The electrically conductive membrane switch of claim 17, wherein the chamber comprises sulfur hexafluoride.

20. The electrically conductive membrane switch of claim 17, wherein the chamber comprises a non-reactive gas.

21. The electrically conductive membrane switch of claim 20, wherein the non-reactive gas is nitrogen or a noble gas.

22. The electrically conductive membrane switch of claim 1, wherein the movable element comprises a piston element.

23. A method of using an electrically conductive membrane pressure switch, wherein
(a) the electrically conductive membrane pressure switch comprises (i) an electrically conductive membrane comprising a suspended section of the electrically conductive membrane, (ii) a source, (iii) a drain plane, (iv) an actuator, and (v) a movable element, and
(b) the method comprises utilizing the actuator to drive the moveable element to create a pressure differential that moves the suspended section of the electrically conductive membrane between on, off, and neutral states, wherein
(i) the electrically conductive membrane is substantially in a plane when the suspended section of the electrically conductive membrane is in the neutral state,
(ii) utilizing the actuator to drive of the movable element away from the electrically conductive membrane results in a pressure drop that moves the suspended section of the electrically conductive membrane away from the source and drain plain to the off state, and
(iii) utilizing the actuator to drive the movable element toward the electrically conductive membrane results in a pressure increase that moves the suspended section of the electrically conductive membrane toward the drain plain to the on state.

24. The method of claim 23, wherein the electrically conductive membrane pressure switch is an electrically conductive membrane pressure switch comprising:
(a) an electrically conductive membrane comprising a suspended section of the electrically conductive membrane;
(b) a source;
(c) a drain plane;
(d) an actuator; and
(e) a movable element, wherein
(i) the actuator is operable to drive the movable element to create a pressure differential that moves the suspended section of the electrically conductive membrane between on, off, and neutral states,
(ii) the electrically conductive membrane is substantially in a plane when the suspended section of the electrically conductive membrane is in the neutral state,
(iii) the driving of the moveable element away from the electrically conductive membrane results in a pressure drop that moves the suspended section of the electrically conductive membrane away from the source and drain plain to the off state, and
(iv) the driving of the movable element toward the electrically conductive membrane results in a pressure increase that moves the suspended section of the electrically conductive membrane toward the drain plain to the on state.
